(19) United States
(12) Patent Application Publication
(10) Pub. No.: US 2008/0133645 A1
(43) Pub. Date: Jun. 5, 2008

(54) SYSTEM AND METHOD FOR PRIORITIZING PRESENCE INFORMATION FOR TELECOMMUNICATION

(75) Inventors: Sharon FRIDMAN, London (GB); Ben Volach, Sterling, VA (US)

Correspondence Address: PATENT ADMINISTRATOR;KATTEN MUCHIN ROSENMAN LLP, 1025 THOMAS JEFFERSON STREET, N.W., EAST LOBBY: SUITE 700, WASHINGTON, DC, 20007-5201, US

(73) Assignee: NeuStar, Inc., Sterling, VA (US)

(21) Appl. No.: 11/777,908

(22) Filed: Jul. 13, 2007

Related U.S. Application Data
(60) Provisional application No. 60/830,350, filed on Jul. 13, 2006.

(51) Int. Cl. G06F 15/16

(52) U.S. Cl. 709/202

(57) ABSTRACT

A system and method are disclosed for prioritizing presence information for telecommunication, referred to as “presence information priority.” Presence information can include, be accompanied by, or otherwise associated with a suitable priority level that indicates the significance of the presence notification. Such presence information priority enables clients to act or otherwise respond to the presence information according to the priority. A presence server or other suitable presence service associates priority indications with the presence information, and sends the presence information and associated priority indications to the client devices. Each client device can receive the same or different priority indication as other client devices for the presence information. The priority information can include a plurality of priority levels, including, for example, “low,” “normal,” and “high.” The presence clients utilize the priority information according to the client's implementations to suitably notify or otherwise alert the client to the priority notification.

The present application claims priority under 35 U.S.C. § 119(e) to U.S. Provisional Application No. 60/830,350, filed on Jul. 13, 2006, the entire contents of which are hereby incorporated by reference herein.

### BACKGROUND

1. Field of the Invention

The present invention relates to telecommunication systems. More particularly, the present invention relates to a system and method for prioritizing presence information for telecommunication, referred to as “presence information priority.”

2. Background Information

A presence and instant messaging (IM) system allows users to subscribe to each other and be notified of changes in state, and to send each other short instant messages. A presence service serves to accept information, store it, and distribute it. The stored information is termed presence information. The presence service includes two kinds of clients. One type of client is called a presentity whose presence information is to be stored and distributed by the presence services. The other kind of client is called a watcher that receives the presence information from the presence service. There are two kinds of watchers: subscribers and fetchers. A subscriber requests notification from the presence service of changes in a presentity's presence information. The presence service honors such a request by providing the presence information upon request or upon changes, depending on the type of subscriber. For example, the subscriber can perform an initial fetch (e.g., current state fetching) and then receive notifications when changes to the presence information occur. A fetcher simply requests the current value of a presentity's presence information from the presence service. A special type of fetcher, called a poller, is one that fetches information on a regular basis.

The presence service also has watcher information about watchers and their activities in terms of fetching or subscribing to presence information. The presence service can also distribute watcher information to some watchers using the same mechanisms that are available for distributing presence information.

FIG. 1 is a block diagram illustrating how changes to presence information are distributed to watchers. Presence attribute A is associated with and describes a presentity 105. FIGS. 1A, 1B, and 1C illustrate the flow of information as the presence attribute A pertaining to the presentity 105 is changed from value A1 to value A2. The presentity 105, the presence service 110, and the watcher 115 each initially maintain the presence attribute A, with a value of A1, on behalf of the presentity 105. In the internal state change step illustrated in FIG. 1A, the value A1 of the presence attribute A associated with the presentity 105 changes to value A2. In the publication step illustrated in FIG. 1B, a suitable publication is sent from the presentity 105 to the presence service 110 indicating that the presence attribute A has changed from value A1 to value A2. Such a publication causes the presence service 110 to update its presence attribute A from value A1 to value A2. In the notification step illustrated in FIG. 1C, a suitable notification is sent from the presence service 110 to the watcher 115 (who is subscribed and is authorized to be notified about the changes to the value of presence attribute A) indicating that the presence attribute A has changed from value A1 to value A2. Such a notification causes the watcher 115 to update the presence attribute A associated with the presentity 105 from value A1 to value A2. All entities now maintain the same value A2 of the presence attribute A for the presentity 105.

However, presence information does not carry an importance indication. Consequently, a watcher (e.g., watcher 115) has no method of discerning between various notifications and their corresponding significance. Accordingly, there is a need for presence clients to be able to act or otherwise respond differently to the priority level or relative significance of the presence information.

### SUMMARY OF THE INVENTION

A system and method are disclosed for prioritizing presence information for telecommunication, referred to herein as “presence information priority.” In accordance with exemplary embodiments of the present invention, according to a first aspect of the present invention, a system for communicating presence information priority to presence clients includes a presence information priority module. The presence information priority module is configured to associate a priority indication with presence information. The system includes a presence information communication module in communication with the presence information priority module. The presence information communication module is configured to communicate the presence information and associated priority indication to a presence client.

According to the first aspect, the presence information priority module can be configured to generate the priority indication in accordance with the presence information. The presence information priority module can be configured to associate a different priority indication with the presence information for each presence client. The presence information priority module can be configured to associate a substantially identical priority indication with the presence information for each presence client. The priority indication can be associated with one of a plurality of priority or severity levels of the presence information. For example, the priority indication can comprise one of a low priority level, a normal priority level, and a high priority level. The priority indication can be configured to cause the presence client to generate an alert notification. For example, the alert notification can comprise at least one of a sound, a presence client awareness activity, and display of an alert message. For example, the priority indication can be configured to cause an alteration in communication between presence clients. The presence information communication module can be configured to communicate the presence information to the presence client when the presence information is associated with a predetermined priority indication. The presence information communication module can be configured to communicate the presence information to the presence client in accordance with a priority profile of the presence client.

According to the first aspect, the system can include a presence information priority filter module in communication with the presence information priority module. The presence information priority filter module can be configured to filter the presence information for a presence client in accordance with a predetermined priority indication. According to an exemplary embodiment of the first aspect, the presence information priority module can be configured to receive the presence information from a presence information source. For example, the presence information source can be configured to assign the priority indication to the presence information. The presence information priority module can be configured to generate a second priority indication for the presence information received from the presence information source. The presence information priority module can be configured to override the priority indication assigned by the presence information source with the second priority indication. Alternatively, the presence information priority module can be configured to associate the priority indication assigned by the presence information source and the second priority indication with the presence information. As an alternative, the presence information priority module can be configured to augment the priority indication assigned by the presence information source.

According to the first aspect, the presence client can be configured to publish the presence information and the associated priority indication. The presence information priority module can be configured to receive presence information priority preferences from the presence client for generating the priority indications. The system can include a presence information priority management module in communication with the presence information priority module. The presence information priority management module can be configured to manage presence information priority preferences for generating priority indications by the presence information priority module. According to an alternative exemplary embodiment of the first aspect, the presence information priority module can be configured to determine whether the presence client supports presence information priority. The presence information priority module can be configured to associate the priority indication with the presence information when it is determined that the presence client supports presence information priority. The presence information communication module can be configured to communicate the presence information and associated priority indication to the presence client when the presence information priority module determines that the presence client supports presence information priority. However, the presence information communication module can be configured to communicate the presence information without the associated priority indication when the presence information priority module determines that the presence client does not support presence information priority.

According to a second aspect of the present invention, a computer-readable medium contains a presence information priority data structure for communicating priority indications with presence information. The presence information priority data structure includes a plurality of presence information tuples. Each presence information tuple includes a status data structure for conveying status information. The status data structure includes a priority indication for conveying presence information priority on the associated presence information. Each presence information tuple includes a communication address data structure. The communication address data structure comprises a communication mechanism data structure for indicating a type of messaging service used to communicate the presence information. The communication address data structure further includes a contact address data structure for indicating an address of an originator of the presence information. According to an additional exemplary embodiment of the second aspect, each presence information tuple can include a markup information data structure.

According to a third aspect of the present invention, a system for prioritizing presence information for telecommunication includes a presence server. The presence server comprises presence information priority structure. The presence information priority structure is configured to associate a priority indication with the presence information. The presence server also includes presence information communication structure in communication with the presence information priority structure. The presence information communication structure is configured to communicate the presence information and associated priority indication to the presence client. According to an additional exemplary embodiment of the third aspect, the presence server includes presence information priority filter structure in communication with the presence information priority structure. The presence information priority filter structure is configured to filter presence information for a presence client in accordance with a predetermined priority indication.

According to a fourth aspect of the present invention, a method of communicating presence information priority to presence clients includes the steps of: generating a priority indication in accordance with presence information; associating the priority indication with the presence information; and communicating the presence information and associated priority indication to the presence client.

According to the fourth aspect, the associating step can include at least one of the following steps: associating a different priority indication with the presence information for each presence client; and associating a substantially identical priority indication with the presence information for each presence client. The priority indication can be associated with one of a plurality of priority or severity levels of the presence information. For example, the priority indication can comprise one of a low priority level, a normal priority level, and a high priority level. The method can include the step of: generating an alert notification by the presence client in response to receipt of the priority indication. For example, the alert notification can comprise at least one of a sound, a presence client awareness activity, display of an alert message, and alteration of communication between presence clients in response to receipt of the priority indication by the presence client.

According to the fourth aspect, the method can include one or more of the following steps: communicating the presence information to the presence client when the presence information is associated with a predetermined priority indication; communicating the presence information to the presence client in accordance with a priority profile of the presence client; and filtering the presence information for a presence client in accordance with a predetermined priority indication. According to an exemplary embodiment of the fourth aspect, the method can include the step of: receiving the presence information from a presence information source. The priority indication generating step can comprises the step of: generating the priority indication for the presence information by the presence information source. Accordingly, the method can include one or more of the following steps: generating a second priority indication for the presence information received from the presence information source; overriding the priority indication generated by the presence information source with the second priority indication; associating the priority indication generated by the presence information source and the second priority indication with the presence information; and augmenting the priority indication generated by the presence information source.

According to the fourth aspect, the method can include one or more of the steps of: receiving presence information priority preferences from the presence client for generating the priority indications; and managing presence information priority preferences for generating priority indications. According to an alternative exemplary embodiment of the fourth aspect, the method can include the steps of: determining whether the presence client supports presence information priority, wherein the priority indication is associated with the presence information when it is determined that the presence client supports presence information priority; communicating the presence information and associated priority indication to the presence client when it is determined that the presence client supports presence information priority; and communicating the presence information without the associated priority indication when it is determined that the presence client does not support presence information priority.

According to a fifth aspect of the present invention, a system for prioritizing presence information for telecommunication includes means for prioritizing presence information. The presence information prioritizing means is configured to associate a priority indication with the presence information. The system includes means for communicating presence information in communication with the presence information prioritizing means. The presence information communicating means is configured to communicate the presence information and associated priority indication to the presence client.

According to the fifth aspect, the presence information prioritizing means can be configured to generate the priority indication in accordance with the presence information. The presence information prioritizing means can be configured to associate a different priority indication with the presence information for each presence client. The presence information prioritizing means can be configured to associate a substantially identical priority indication with the presence information for each presence client. The priority indication can be associated with one of a plurality of priority or severity levels of the presence information. For example, the priority indication can comprise one of a low priority level, a normal priority level, and a high priority level. The priority indication can be configured to cause the presence client to generate an alert notification. For example, the alert notification can comprise at least one of a sound, a presence client awareness activity, and display of an alert message. Alternatively, the priority indication can be configured to cause an alteration in communication between presence clients. The presence information communicating means can be configured to communicate the presence information to the presence client when the presence information is associated with a predetermined priority indication. The presence information communicating means can be configured to communicate the presence information to the presence client in accordance with a priority profile of the presence client.

According to the fifth aspect, the system can include means for filtering presence information priority in communication with the presence information prioritizing means. The presence information priority filtering means is configured to filter the presence information for a presence client in accordance with a predetermined priority indication. The presence information prioritizing means can be configured to receive the presence information from a presence information source. The presence information source can be configured to assign the priority indication to the presence information. The presence information prioritizing means can be configured to generate a second priority indication for the presence information received from the presence information source. The presence information prioritizing means can be configured to override the priority indication assigned by the presence information source with the second priority indication. The presence information prioritizing means can be configured to associate the priority indication assigned by the presence information source and the second priority indication with the presence information. The presence information prioritizing means can be configured to augment the priority indication assigned by the presence information source.

According to the fifth aspect, the presence client can be configured to publish the presence information and the associated priority indication. The presence information prioritizing means can be configured to receive presence information priority preferences from the presence client for generating the priority indications. The system can include means for managing presence information priority in communication with the presence information prioritizing means. The presence information priority managing means can be configured to manage presence information priority preferences for generating priority indications by the presence information prioritizing means. According to an alternative exemplary embodiment of the fifth aspect, the presence information prioritizing means can be configured to determine whether the presence client supports presence information priority. The presence information prioritizing means can be configured to associate the priority indication with the presence information when it is determined that the presence client supports presence information priority. The presence information communicating means can be configured to communicate the presence information and associated priority indication to the presence client when the presence information prioritizing means determines that the presence client supports presence information priority. However, the presence information communicating means can be configured to communicate the presence information without the associated priority indication when the presence information prioritizing means determines that the presence client does not support presence information priority.

According to a sixth aspect of the present invention, a system for prioritizing presence information for telecommunication includes a presence information priority module. The presence information priority module is configured to determine whether a presence client supports presence information priority. The presence information priority module is configured to associate a priority indication with the presence information when it is determined that the presence client supports presence information priority. The system includes a presence information communication module in communication with the presence information priority module. The presence information communication module is configured to communicate the presence information and associated priority indication to the presence client when the presence information priority module determines that the presence client supports presence information priority.

According to a seventh aspect of the present invention, a system for prioritizing presence information for telecommunication includes a presence server. The presence server includes presence information priority structure. The presence information priority structure is configured to determine whether a presence client supports presence information priority. The presence information priority structure is configured to associate a priority indication with the presence information when it is determined that the presence client supports presence information priority. The presence server also includes presence information communication structure in communication with the presence information priority structure. The presence information communication structure is configured to communicate the presence information and associated priority indication to the presence client.

According to an eighth aspect of the present invention, a method of prioritizing presence information for telecommunication includes the steps of: determining whether a presence client supports presence information priority; associating a priority indication with the presence information when it is determined that the presence client supports presence information priority; and communicating the presence information and associated priority indication to the presence client when it is determined that the presence client supports presence information priority.

### BRIEF DESCRIPTION OF THE DRAWINGS

Other objects and advantages of the present invention will become apparent to those skilled in the art upon reading the following detailed description of preferred embodiments, in conjunction with the accompanying drawings, wherein like reference numerals have been used to designate like elements, and wherein:

FIG. 1 is a block diagram illustrating how changes to presence information are distributed to watchers.

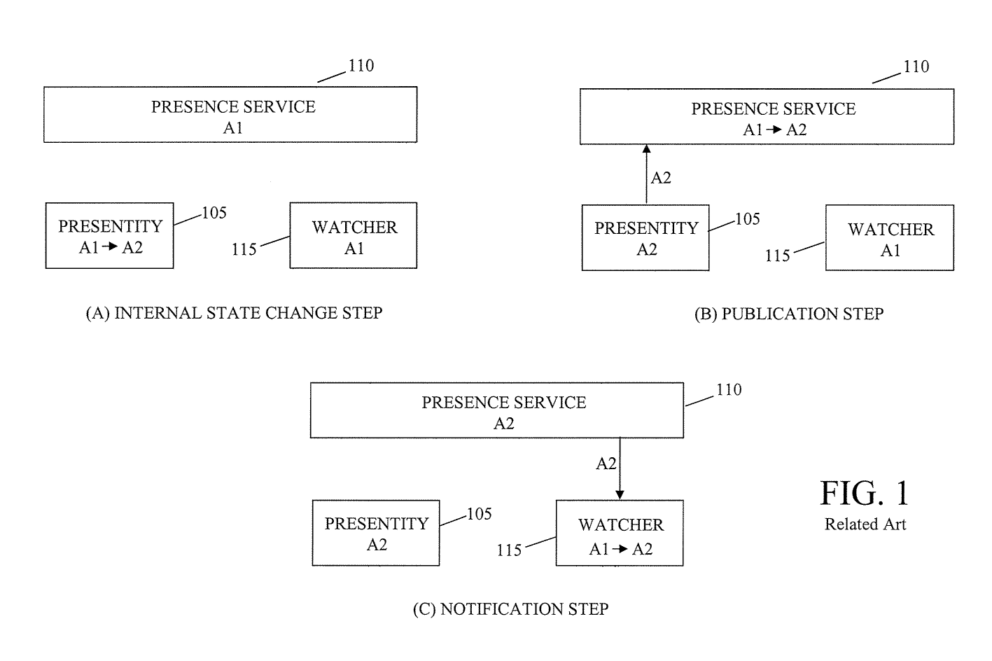

FIG. 2 is a block diagram illustrating a system for communicating presence information priority to presence clients, in accordance with an exemplary embodiment of the present invention.

FIG. 3 is a block diagram illustrating how presence information priority is communicated to presence clients, in accordance with an exemplary embodiment of the present invention.

FIG. 4 illustrates a presence information priority data structure that incorporates a priority indication into the presence information, in accordance with an exemplary embodiment of the present invention.

FIG. 5 is a block diagram illustrating a system for prioritizing presence information for telecommunication, in accordance with an alternative exemplary embodiment of the present invention.

FIG. 6 is a flowchart illustrating steps for communicating presence information priority to presence clients, in accordance with an exemplary embodiment of the present invention.

FIG. 7 is a flowchart illustrating steps for prioritizing presence information for telecommunication, in accordance with an alternative exemplary embodiment of the present invention.

### DETAILED DESCRIPTION OF THE PREFERRED EMBODIMENTS

Exemplary embodiments of the present invention are directed to a system and method for prioritizing presence information for telecommunication, referred to herein as “presence information priority.” According to exemplary embodiments, presence information can include, be accompanied by, or otherwise be associated with a suitable priority level that indicates the significance of the presence notification. Such presence information priority can enable clients to act or otherwise respond to the presence information according to the priority. A presence server or other suitable presence service can associate priority indications with the presence information (e.g., using suitable rules or algorithms to determine the appropriate priority indication), and send the presence information and associated priority indications to the client devices. Each client device can receive the same or different priority indication as other client devices for the presence information. The priority information can include a plurality of priority levels, including, for example, “low,” “normal,” and “high.” The presence clients can utilize the priority information according to the client's implementations to suitably notify or otherwise alert the client to the priority notification.

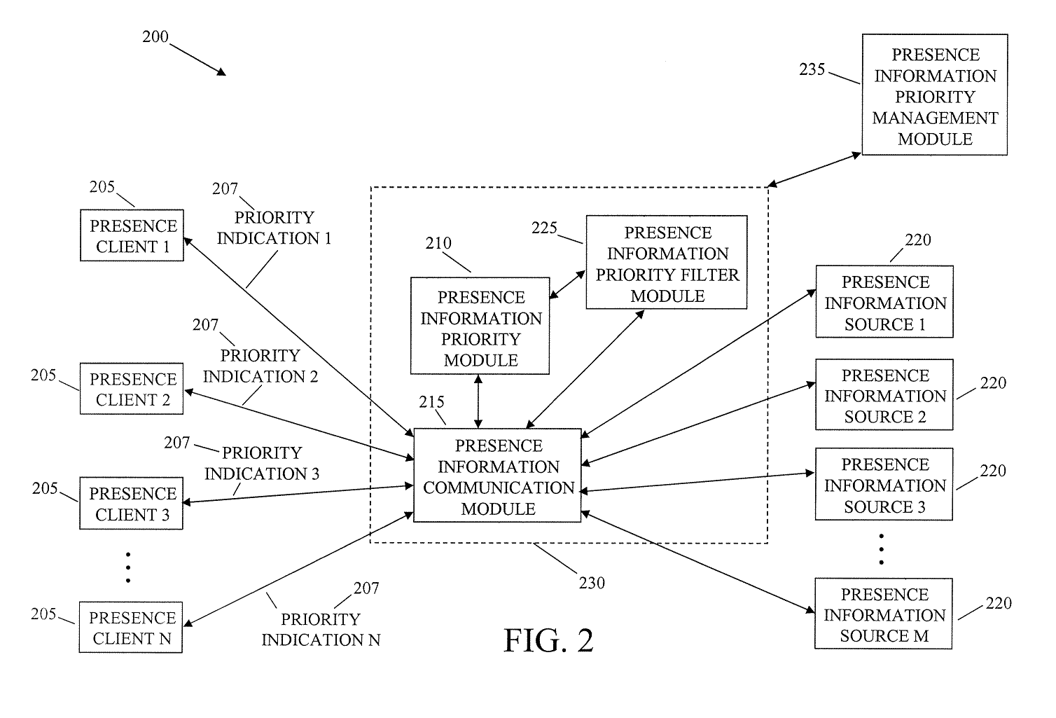

These and other aspects and embodiments of the present invention will now be described in greater detail. FIG. 2 is a block diagram illustrating a System 200 for communicating presence information priority to Presence Clients 205, in accordance with an exemplary embodiment of the present invention. The System 200 can support any suitable number of Presence Clients 205 (e.g., Presence Client 1, Presence Client 2, Presence Client 3, . . . , Presence Client N, where N is any suitable number). Each of the Presence Clients 205 can be considered a “subscriber,” or, more generally, a “watcher” in the presence System 200. Each Presence Client 205 can be any suitable type of wireless or wired communication device that is capable of receiving and processing presence information, such as, for example, an instant messaging (IM) client or the like.

The System 200 includes a Presence Information Priority Module 210. The Presence Information Priority Module 210 is configured to include, accompany, or otherwise associate a priority indication 207 with the presence information. According to exemplary embodiments, the priority indication 207 can represent one (or a combination) of a plurality of priority or severity levels of the presence information. For purposes of illustration and not limitation, the priority indication 207 can comprise a LOW priority level, a NORMAL priority level, or a HIGH priority level. However, the priority indications 207 can be comprised of any suitable number of priority levels, each having any appropriate type of designation. For example, the priority indications 207 can be comprised of two levels, such as NO priority and YES priority. Alternatively, the priority indications 207 can be comprised of a plurality of numerical designations, such as the numbers 0 to 10, where 0 can represent no priority and 10 can represent highest or maximum priority. Those of ordinary skill in the art will recognize that the number and types of priority indications 207 will depend on the particular implementation, the use cases that may be encountered (and for which priority indications 207 will be needed or desired), the nature and functionality of the Presence Clients 205, and other like factors.

According to an exemplary embodiment, the Presence Information Priority Module 210 can be configured to associate a different priority indication 207 with the presence information for each Presence Client 205. In other words, different Presence Clients 205 can receive different priority indications 207 for the same presence information. For example, a first priority indication 207 can be associated with the presence information for the first Presence Client 205, a second priority indication 207 can be associated with the presence information for the second Presence Client 205, a third priority indication 207 can be associated with the presence information for the third Presence Client 205, and an Nth priority indication 207 can be associated with the presence information for the Nth Presence Client 205. Thus, the priority indications 207 can be specific or otherwise tailored to each individual Presence Client 205, or any suitable combination of such clients, for any presence information. Accordingly, each Presence Client 205 can receive a priority indication 207 that can be the same as or different than the priority indications 207 received by one or more other Presence Clients 205 for the presence information. For example, according to an alternative exemplary embodiment, the Presence Information Priority Module 210 can be configured to associate a substantially identical priority indication 207 with the presence information for each presence client 207 or any appropriate combination of such clients. However, the Presence Information Priority Module 210 can associate one or more priority indications 207 with any suitable presence information for each, any combination, or all of the Presence Clients 205.

The System 200 includes a Presence Information Communication Module 215 in communication with the Presence Information Priority Module 210. The Presence Information Communication Module 215 is configured to communicate the presence information and the associated priority indication 207 to the Presence Client 205. The Presence Information Communication Module 215 can communicate with each of the Presence Clients 205 using any suitable wireless or wired communication technique or mechanism.

According to an exemplary embodiment, the Presence Information Priority Module 210 can be configured to generate the priority indication 207 in any suitable manner. According to an exemplary embodiment, the Presence Information Priority Module 210 can be configured to generate the priority indication 207 in accordance with the presence information. In other words, the priority indication 207 will depend on the presence information received, processed, and communicated by the Presence Information Priority Module 210. For purposes of illustration and not limitation, in a weather application, a Presence Client 205 can subscribe to weather information of a city. Updates of a relatively small change of the temperature (e.g., an increase in temperature from 22° C. to 23° C.) can be notified by the Presence Information Priority Module 210 with a low priority. However, significant changes in the climate (e.g., a change from sunshine to rain) can result in the Presence Information Priority Module 210 associating a high priority level to such presence information so that the Presence Client 205 can be alerted to take appropriate actions or measures to address the (significant) change in weather conditions.

According to one exemplary embodiment, the Presence Information Priority Module 210 can include appropriate look-up tables that can map presence information to various predetermined priority indications 207. Such look-up tables can be stored in a suitable computer memory or other computer storage device internal to or in communication with the Presence Information Priority Module 210. Continuing with the present illustration, if the temperature change is less than 5 degrees, then the look-up table can indicate that such a situation corresponds to a low (or normal) priority level. If the temperature change is greater than 20 degrees, then the look-up table can indicate that such a situation corresponds to a high priority level. If the weather changes from sunshine to rain, then the look-up table can indicate that such a situation is also a high priority level. As skilled artisans will recognize, the nature and content of the information contained in such a look-up table and the mapping of the presence information to priority indications or levels 207 will depend on, for example, the nature and type of the presence information and other like factors.

Alternatively, suitable Boolean or other logic or rules can be used to determine the priority indication 207 to associate with the presence information. For example, continuing with the present illustration, Boolean logic can be used to determine that IF the temperature change is less than 5 degrees, THEN the priority indication 207 is low. Likewise, Boolean logic can be used to determine that IF the temperature change is more than 20 degrees, THEN the priority indication 207 is high. Finally, Boolean logic can be used to determine that IF the weather changes from sunshine to rain, THEN the priority indication 207 is high. The complexity of such logic or rules will depend on the nature and type of presence information, as well as other like factors. More complex mechanisms, such as neural networks, can be adapted to “learn” how to respond to such presence information. For example, according to an exemplary embodiment, the Presence Information Priority Module 210 can “learn” that a change in weather from sunshine to rain requires a high priority indication 207. Such information can be fed back to the Presence Information Priority Module 210 to allow such “learning” to take place and to refine these or other priority determination algorithms.

According to an exemplary embodiment, the Presence Information Priority Module 210 can be configured to receive the presence information from one or more remote or otherwise external Presence Information Sources 220, for example, via the Presence Information Communication Module 215. The Presence Information Priority Module 210 can be in communication with any suitable number of Presence Information Sources 220 (e.g., Presence Information Source 1, Presence Information Source 2, Presence Information Source 3, . . . , Presence Information Source M, where M is any suitable number). Each of the Presence Information Sources 220 can be considered a “presentity” in the presence System 200. According to an exemplary embodiment, each, any, or all of the Presence Information Sources 220 can be configured to assign a priority indication 207 to the presence information that is communicated or otherwise passed to the Presence Information Priority Module 210. For example, a Presence Information Source 220 that is responsible for publishing the weather information can assign a priority according to the difference between the original weather and the new weather. Such priority indications 207 can then be passed to the appropriate Presence Client 205 by the Presence Information Priority Module 210 (via the Presence Information Communication Module 215). According to an exemplary embodiment, the Presence Information Priority Module 210 can be configured to augment or otherwise modify the priority indication 207 assigned by the Presence Information Source 220 (e.g., to raise or lower the priority indication 207 in accordance with rules or preferences maintained by the Presence Information Priority Module 210).

According to an additional exemplary embodiment, the Presence Information Priority Module 210 can be configured to generate its own priority indication 207 for the presence information in addition to that received from the Presence Information Source 220. The Presence Information Priority Module 210 can be configured to override the priority indication 207 from the Presence Information Source 220 under appropriate circumstances when its priority indication 207 differs from that assigned by the Presence Information Source 220. For purposes of illustration and not limitation, a Presence Client 205 can establish a preference that all weather information is to be assigned a HIGH priority indication 207. If weather information is received from the Presence Information Source 220 with a LOW priority indication 207, the Presence Information Priority Module 210 can modify that priority indication 207 from LOW to HIGH per the client's preference. According to an alternative exemplary embodiment, the Presence Information Priority Module 210 can be configured to associate its generated priority indication 207 and the priority indication 207 assigned by the Presence Information Source 220 with the presence information. The Presence Client 205 can then receive multiple priority indications 207 or a suitable combination of priority indications 207 for the presence information.

Thus, according to various exemplary embodiments, the Presence Information Source 220 need not assign any priority indication 207, and the Presence Information Priority Module 210 can generate its own priority indication 207 for the presence information. Alternatively, the Presence Information Source 220 can set or otherwise assign the priority indication 207, and the Presence Information Priority Module 210 can accept and propagate the assigned priority indication 207. Otherwise, the Presence Information Source 220 can assign the priority indication 207, which can then be overridden by the Presence Information Priority Module 210 with another priority indication 207 (or be sent in addition to the priority indication 207 assigned by the Presence Information Source 220). As an alternative, the Presence Information Source 220 can set the priority indication 207, but that priority indication 207 can be modified or otherwise augmented by the Presence Information Priority Module 210. Consequently, any priority indication 207 assigned by the Presence Information Source 220 need not be the same priority indication 207 that is communicated to the Presence Clients 205 by the Presence Information Priority Module 210, and can be different for each Presence Client 205.

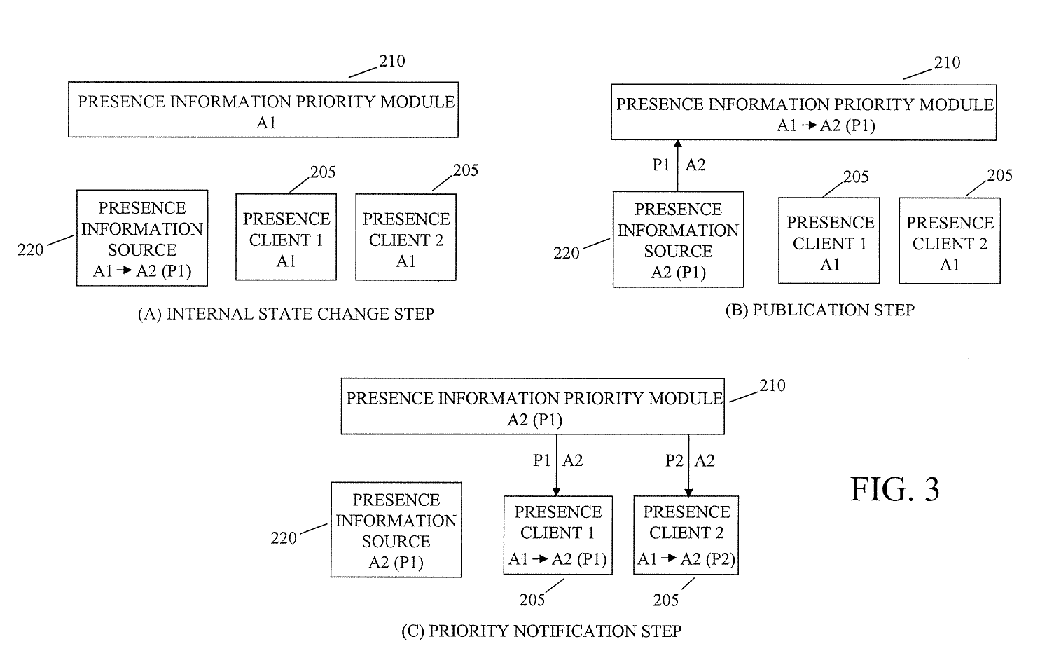

FIG. 3 is a block diagram illustrating how presence information priority is communicated to Presence Clients 205, in accordance with an exemplary embodiment of the present invention. Presence information A is associated with the Presence Information Source 220 (e.g., a presentity). FIGS. 3A, 3B, and 3C illustrate the flow of information as the presence information A pertaining to the Presence Information Source 220 is changed from value A1 to value A2, along with the presence priority information associated with that change. The Presence Information Source 220, the Presence Information Priority Module 210 (e.g., a presence service), and the first and second Presence Clients 205 (e.g., watchers) each initially maintain the presence information A, with a value of A1, on behalf of the Presence Information Source 220 (no initial priority is assigned). In the internal state change step illustrated in FIG. 3A, the value A1 of the presence information A associated with the Presence Information Source 220 changes to value A2. In addition, the Presence Information Source 220 assigns an initial priority indication of P1 to the change. In the publication step illustrated in FIG. 3B, a suitable publication is sent from the Presence Information Source 220 to the Presence Information Priority Module 210 (via the Presence Information Communication Module 215) indicating that the presence information A has changed from value A1 to value A2, and that the initial priority indication of P1 has been assigned. Such a publication causes the Presence Information Priority Module 210 to update its presence information A from value A1 to value A2, and to associate the initial priority indication of P1 to that presence information.

In the notification step illustrated in FIG. 3C, a suitable notification is sent from the Presence Information Priority Module 210 to the first and second Presence Clients 205 (via the Presence Information Communication Module 215) indicating that the presence information A has changed from value A1 to value A2. In the present illustration, the Presence Information Priority Module 210 passes the initial priority indication of P1 to the first Presence Client 205, for example, in accordance with preferences or rules established for the first Presence Client 205 (e.g., always use the priority indication assigned by the given Presence Information Source 220). Such a notification causes the first Presence Client 205 to update the presence information A associated with the Presence Information Source 220 from value A1 to value A2, and causes an appropriate response in accordance with the priority indication of P1 (e.g., the first Presence Client 205 beeps). The Presence Information Priority Module 210 overrides or otherwise changes the priority indication to P2 for the second Presence Client 205, for example, in accordance with preferences or rules established for the second Presence Client 205 (e.g., always raise the priority indication assigned by the given Presence Information Source 220 by one level). Such a notification causes the second Presence Client 205 to update the presence information A associated with the Presence Information Source 220 from value A1 to value A2, and causes an appropriate response in accordance with the priority indication of P2 (e.g., the second Presence Client 205 vibrates and flashes). All entities now maintain the same value A2 of the presence information A for the Presence Information Source 220. However, the first and second Presence Clients 205 respond differently to the notifications due to the different priority indications sent to each client by the Presence Information Priority Module 210.

According to exemplary embodiments, the priority indication 207 can be communicated to those Presence Clients 205 as a portion or part or otherwise incorporated into the presence information (e.g., as in-band data), or as a piece of information that is separate to, but accompanies, the presence information (e.g., as out-of-band data). If the priority indication 207 is separate from, but associated with, the presence information, the priority indication 207 can be sent separately from the presence information (e.g., either before, with, or after the presence information) as, for example, suitable meta data.

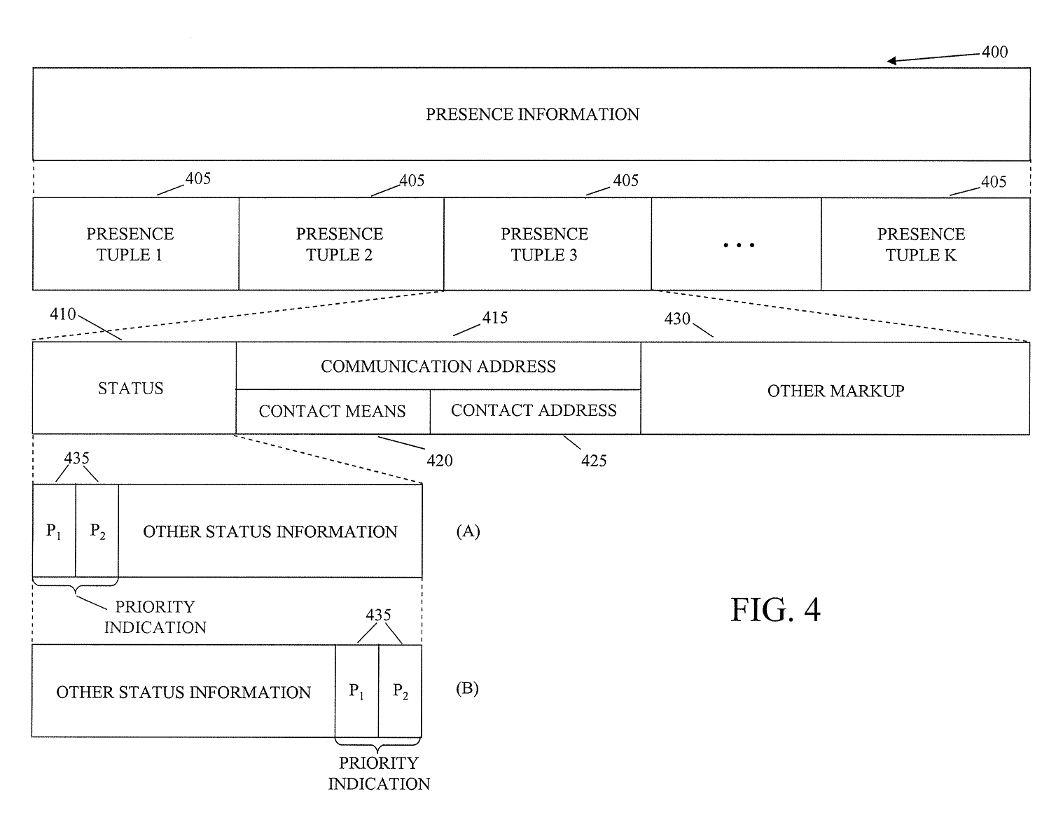

Alternatively, FIG. 4 illustrates a presence information priority data structure 400 that incorporates a priority indication into the presence information, in accordance with an exemplary embodiment of the present invention. The presence information priority data structure 400 can be comprised of any suitable number of presence information tuples 405 (e.g., presence information tuple 1, presence information tuple 2, presence information tuple 3, . . . , presence information tuple K, where K is any appropriate number). Each presence information tuple 410 includes a status data structure 410. The status data structure 410 can convey such information as, for example, “online,” “offline,” “busy,” “away,” “do not disturb,” and other like status information. Each presence information tuple 410 can include an optional communication address data structure 415 that can comprise a communication mechanism data structure 420 and a contact address data structure 425. The communication mechanism data structure 420 indicates the type of messaging service used to communicate the presence information, such as, for example, an IM service, an appropriate form of telephony, or the like. The contact address data structure 425 indicates the address of the originator of the presence information (or recipient, depending on the implementation), such as, for example, the instant message inbox address, a telephone number, or the like. Each presence information tuple 405 can include an additional markup information data structure 430 as appropriate for the communication mechanism and presence information. For example, for an IM service, the status data structure 410 can have at least two states that can interact with instant message delivery: “open,” in which instant messages will be accepted, and “closed,” in which instant messages will not be accepted. Such “open” and “closed” states can also be applicable to other communication mechanisms or means. For example, “open” can be mapped to a state that represents “available” or “open for business,” while “closed” can represent “unavailable” or “closed to business.”

The status data structure 410 of each presence information tuple 405 can include additional or alternative values to support the priority indications according to exemplary embodiments. According to such an exemplary embodiment, the status data structure 405 includes a priority indication 435. For purposes of illustration and not limitation, the priority indication 435 can be comprised of two digits “P₁P₂,” although the priority indication 435 can be comprised of any suitable number of digits, bits, bytes, or other like information (depending on, for example, the number and types of priority indications supported by the System 200). In FIG. 4A, the priority indication 435 is located as the first two digits of the status data structure 410. Alternatively, as illustrated in FIG. 4B, the priority indication 435 is the last two digits of the status data structure 410. However, the priority indication 435 can be located at any suitable position or location within the status data structure 410 or another data structure in the presence information tuple 405 (e.g., within the markup information data structure 430). According to the present illustration, the combination of the two digits for the priority indication 435 can be used to represent the priority level of the associated presence information. For example, Table 1 illustrates exemplary priority levels that can correspond to the various combinations of priority indication digits “P₁P₂”:

TABLE 1
Exemplary mapping of priority indications to priority levels

| P₁ | P₂ | PRIORITY LEVEL |
|---|---|---|
| 0 | 0 | NO priority or priority not supported |
| 0 | 1 | LOW |
| 1 | 0 | NORMAL |
| 1 | 1 | HIGH |

However, the priority indications 207 can be communicated as either in-band or out-of-band data as part of or with any suitable protocol or other communication data structure or mechanism. For example, the priority indications 207 can be included in a suitable protocol-level header and not embedded inside the presence information or tuple attribute (e.g., such as an XML attribute to an XML tuple). For purposes of illustration and not limitation, such protocol headers can include, for example, a Session Initiation Protocol (SIP) header, HTTP header, or the like. Alternatively, the priority indications 207 can be included as Extensible Messaging and Presence Protocol (XMPP) embedded data, as part of Presence Information Document Format (PIDF) status, or other like protocols or data formats. Those of ordinary skill in the art will recognize that the manner in which the priority indications 207 are communicated to the Presence Clients 205 will depend on the nature and type of communication protocol and messaging/communication service used. For example, a priority indication 207 embedded in or with the presence information can denote different priorities to different Presence Clients 205 or other presence elements, and as such can support more complex presence information priority rules. However, a priority indication 207 in a protocol header may merely allow for simple or less complex presence information priority rules (e.g., several pieces of changed presence information may all be given a single priority indication).

According to an exemplary embodiment, the Presence Information Priority Module 210 can be configured to receive presence information priority preferences from the Presence Client 205 (via the Presence Information Communication Module 215) for generating the priority indications 207. For example, a Presence Client 205 can establish a preference that all weather information be assigned a HIGH priority indication by the Presence Information Priority Module 210. Thus, each or any of the Presence Clients 205 can set priorities for presence information that is requested by the client. The Presence Information Priority Module 210 can be configured to receive (e.g., via the Presence Information Communication Module 215) presence information priority preferences from the Presence Client 205 for generating the priority indications 207. Accordingly, the Presence Clients 205 can proactively set preferences/policy to modify the presence priority of notifications. The Presence Information Priority Module 210 and the Presence Information Communication Module 215 can be configured to communicate the presence information to the Presence Client 205 when the presence information is associated with a predetermined priority indication 207. In other words, a Presence Client 205 can assign certain priority levels for various presence information so that the Presence Client 205 is notified when the presence information has an associated priority level that is equal (and/or greater or lesser) to that assigned by the Presence Client 205. For example, a Presence Client 205 can subscribe to weather information and can assign a HIGH priority preference to that information, so that only weather information with a priority level equal to or greater than HIGH is communicated to the Presence Client 205. As an additional example, a Presence Client 205 can get NORMAL priority notifications on stocks generally, but define a “My Stocks” list or the like, so that notifications for such personalized stock choices can arrive as HIGH priority. The Presence Information Priority Module 210 and the Presence Information Communication Module 215 can also be configured to communicate the presence information to the Presence Client 205 in accordance with a “priority profile” of the Presence Client 205. Such a priority profile can be, for example, a collection or list of the various types or kinds of presence information to which a Presence Client 205 subscribes, and the priority levels and/or range of priority levels assigned to each type or kind of presence information.

Accordingly, the System 200 can include a Presence Information Priority Filter Module 225 in communication with the Presence Information Priority Module 210 and the Presence Information Communication Module 215, as illustrated in FIG. 2. The Presence Information Priority Filter Module 225 can be configured to filter presence information for each or any Presence Client 205 in accordance with predetermined priority indications 207. The Presence Client 205 can subscribe to presence information and assign various priority preferences to that presence information. Such preferences can be passed to the Presence Information Priority Filter Module 225 through the Presence Information Priority Module 210 or directly from the Presence Information Communication Module 215. The presence information can be filtered by the Presence Information Priority Filter Module 225 according to the assigned priority preferences. Thus, notifications associated with such presence information can be sent to the Presence Client 205 according to the priority selected by the client in the manner discussed previously. The Presence Client 205 can select to subscribe to one or multiple priorities for any piece, type, or kind of presence information (e.g., to receive notifications for presence information that is within a range of priority levels, equal to a priority level, less than or greater than a priority level, or any suitable combination thereof). As will be discussed below, any of the entities of the System 200 can set or otherwise assign such priority preferences or rules, and all such preferences and rules can be used by the Presence Information Priority Filter Module 225 to filter the presence information for those entities.

According to exemplary embodiments, the priority indication 207 is configured to cause the Presence Client 205 to generate a suitable alert notification. The nature and type of alert notification will depend on the functionality supported by and the implementations of the Presence Client 205. In other words, the priority indication 207 can be handled by the Presence Client 205 at its discretion, including any suitable audio/visual mechanism, immediate or deferred alert, a predetermined, random, or policy-based alert mechanism, or any other suitable form of alert mechanism or means that utilizes the priority indications 207. For example, the alert notification can comprise a sound, such as a beep or other generic or specific aural indication, on incoming notification. Additionally or alternatively, the alert notification can comprise a Presence Client 205 awareness activity, such as, for example, vibration, flashing, or other such physical, tactile, or visual manifestation of an alert notification. The alert notification can also or alternatively comprise the display of an alert message, such as, for example, an intrusive dialog message that is appropriate for the given context. Additionally or alternatively, the priority indications 207 can trigger any suitable application to cause any appropriate user action, immediately or deferred. For example, the priority indication 207 can be configured to cause an alteration or other modification or change in communication between Presence Clients 205, such as when the presence information of one of the Presence Clients 205 has changed. For purposes of illustration and not limitation, a priority indication 207 can be received by a mother from her child indicating a change in status to “HELP.” When the mother then calls the child, the priority indication 207 can cause the call to be automatically routed to 911, or a menu item can be displayed to the mother for placing such an emergency call. Such alert responses can be governed by suitable preferences or rules.

Each or any combination of such alert notifications can be used by each Presence Client 205. Thus, for a low (or normal) priority indication 207, the Presence Client 205 need not generate any alert notification or can generate an alert notification that is unobtrusive, so that in either case the user is not being distracted. However, high priority indications 207 can result in an obtrusive notification, such as, for example, a beep and/or pop-up message, alerting the user to the updated information. The Presence Client 205 can take any other appropriate action(s) in accordance with the received presence information and accompanying priority indication 207. For example, the Presence Client 205 can be configured to publish the presence information and the associated priority indication 207, such as its presence information priority preferences.

According to an exemplary embodiment, the Presence Information Priority Module 210, the Presence Information Communication Module 215, and the Presence Information Priority Filter Module 225 (or combinations thereof) can comprise or otherwise be components of a suitable presence service or Presence Server 230. In addition, the System 200 can include a Presence Information Priority Management Module 235 in communication with the Presence Server 230 (e.g., via the Presence Information Communication Module 215). For example, the Presence Information Priority Management Module 235 can be configured to manage presence information priority preferences for generating priority indications 207 by the Presence Information Priority Module 210. The Presence Information Priority Management Module 235 can be used by, for example, a service provider, a system administrator, operator, or the like to manage and maintain any or all aspects of the Presence Server 230. For example, if a service provider uses the Presence Information Priority Management Module 235 to assign a high priority to certain types of presence information, the Presence Server 230 can use such priority information for various suitable purposes (e.g., logging or otherwise recording presence or other information, providing higher quality of service or faster routing of information or other forms of optimization, and the like).

Thus, according to exemplary embodiments, the priority indications 207 can be set or otherwise assigned according to preferences and/or profiles established by the Presence Clients 205 (e.g., watchers), the Presence Information Sources 220 (e.g., the presentities), the Presence Server 230 (e.g., the presence service), and/or the Presence Information Priority Management Module 235 (e.g., the service provider and/or operator). Such preferences and/or policies can use any suitable type of rule-based format, such as, for example, XML rules, appropriate database rules, other expert system rules, or the like. For purposes of illustration and not limitation, a rule can be set up such that any publication by an under-aged child generates a high priority indication to the child's family members. The service provider/operator can provide rules for “binding” the family members so that the child's family can be notified, the presence service can maintain age rules for determining whether the child is underage, and the operator can establish an appropriate rule so that such behavior causes the presence service to automatically create the high priority indication.

The following example is provided to illustrate how the Presence Information Priority Module 210 can use suitable rules/preferences from multiple sources, as discussed above, to generate and associate the priority indications 207. The present example is merely for purposes of illustration and not limitation, as those of ordinary skill in the art will recognize that the particular rules, logic, preferences, and/or algorithms used by the Presence Information Priority Module 210 will depend on numerous factors, including the rules or preferences specified by the presentities, watchers, service providers/operators, and the like, as well as the specifics of the particular implementation of the System 200.

In the present example, the Presence Information Source 220 (e.g., a presentity) is a child, a Presence Client 205 is a parent (e.g., a first watcher), and another Presence Client 205 is a nanny (e.g., a second watcher). Each priority indication 207 can be a LOW, MEDIUM, or HIGH priority level. Table 2 illustrates the watcher and service provider rules that can be set up for generating and associating priority indications 207 by the Presence Information Priority Module 210 in the System 200.

TABLE 2
Illustrative watcher and service provider rules.

| | | | SERVICE |
|---|---|---|---|
| | | | PROVIDER |
| PRESENTITY | WATCHER | WATCHER RULES | RULES |
| Child | Parent | Assign HIGH if | |
| | | presence information | |
| | | includes location | |
| | | change to | |
| | | neighborhood X. | |
| Child | Nanny | Assign HIGH if time | |
| | | is between 07:30 and | |
| | | 16:30, unless | |
| | | weekend then assign | |
| | | MEDIUM. | |
| Child | | | Assign HIGH |
| | | | if status |
| | | | contains |
| | | | “HELP” |

As illustrated in Table 2, the parent (the first watcher) establishes a rule for the child (the presentity) that the Presence Information Priority Module 210 is to assign a HIGH priority indication if the presence information notification indicates that the child has changed location to a certain neighborhood (i.e., neighborhood X). The nanny (the second watcher) establishes a rule for the child that the Presence Information Priority Module 210 is to assign a HIGH priority indication if the presence information notification indicates a time between 07:30 and 16:30, but if it is the weekend then assign a MEDIUM priority. The service provider establishes a rule for the child that a HIGH priority indication is to be assigned if the status contains “HELP.” By default, presence information from the child can be associated with a LOW priority indication.

Using the aforementioned rules set up by the various entities, the Presence Information Priority Module 210 can generate or otherwise calculate the appropriate priority indication to associate with presence information from the child for distribution to the parent and nanny. For example, the child visits neighborhood X at 10:00 a.m. on a Saturday, and an appropriate presence information notification can indicate as such. Presence information from the child is given a LOW priority indication by default by the Presence Information Priority Module 210. However, based on the rule established by the parent, the Presence Information Priority Module 210 raises the priority indication to HIGH, as the child has changed location to neighborhood X. The parent thus receives a HIGH priority indication with the presence information. Based on the rule established by the nanny, the Presence Information Priority Module 210 raises the priority indication to MEDIUM—although the time is 10:00 a.m., it is on the weekend, so a HIGH priority is not warranted according to the nanny's rule. The nanny thus receives a MEDIUM priority indication with the presence information. It is noted that the rule for the service provider is not invoked, as the status of the presence information from the child did not contain “HELP.”

Thus, priority indications can be tailored to individual, groups of, or all Presence Clients 205. For example, a service provider or operator can assign rules per group or domain (e.g., a “HELP” rule for all presentities that are children), and not merely for each presentity-watcher set. In addition, presentities can set rules for a presentity-watcher set, in the same manner as watchers (e.g., a child does not want a HIGH priority indication for a particular location change so as not to worry the parent, and the parent agrees to such a rule). Many other combinations and sets of rules can be established by each of the entities of the System 200, and the Presence Information Priority Module 210 can use any and all such rules to generate and associate appropriate priority indications with the presence information.

If a Presence Client 205 is not configured to support or otherwise use the presence information priority, those Presence Clients 205 can simply ignore the priority indications 207 that are received. However, according to an alternative exemplary embodiment, the Presence Information Priority Module 210 can be configured to include, accompany, or otherwise associate priority indications 207 with the presence information when it is determined that the Presence Client 205 supports presence information priority. The Presence Server 230 or other suitable presence service can distinguish between client devices (e.g., subscribers) that support presence information priority and those that do not, and can send the priority indication 207 to the client devices that do support such priority information. Accordingly, the Presence Information Priority Module 210 can be configured to determine whether a Presence Client 205 supports presence information priority. The Presence Information Communication Module 215 can be configured to communicate the presence information and the associated priority indication 207 to the Presence Client 205 when the Presence Information Priority Module 210 determines that the Presence Client 205 supports presence information priority. However, the Presence Information Communication Module 215 can be configured to communicate the presence information without the associated priority indication 207 when the Presence Information Priority Module 210 determines that the Presence Client 205 does not support presence information priority.

According to an exemplary embodiment, the Presence Information Priority Module 210 can maintain or otherwise store a look-up table (e.g., in an appropriate computer memory or other associated computer storage medium) that maps each client device 205 to whether the device supports presence information priority. For purposes of illustration and not limitation, Table 3 illustrates an exemplary look-up table that can be used by the Presence Information Priority Module 210:

TABLE 3
Example of Look-Up Table

| PRESENCE | CLIENT DEVICE SUPPORTS PRESENCE |
|---|---|
| CLIENT | INFORMATION PRIORITY? |
| 1 | YES |
| 2 | NO |
| 3 | NO |
| 4 | YES |
| 5 | YES |
| . . . | . . . |
| N | YES |

For each row in Table 3, the Presence Client 205 can be associated with a positive or negative indication of whether the client device supports presence information priority. However, the Presence Information Priority Module 210 can determine whether each Presence Client 205 supports presence information priority in any suitable manner. For example, the Presence Information Priority Module 210 can be configured to query each Presence Client 205 (e.g., by communicating or causing to communicate a suitable query message to the Presence Client 205) to retrieve the appropriate information for making such a determination. Thus, the Presence Information Priority Module 210 can be configured to distinguish between Presence Clients 205 that support presence information priority and those that do not, so that priority indications 207 are sent to those clients that do support such functionality.

Those of ordinary skill in the art will recognize that each of the modules of the System 200 can be located locally to or remotely from each other, while use of the System 200 as a whole still occurs within a given country, such as the United States. For example, merely for purposes of illustration and not limitation, the Presence Information Priority Module 210, the Presence Information Communication Module 215, the Presence Information Sources 220, the Presence Information Priority Filter Module 225, and the Presence Information Priority Management Module 235 (or any combination of such modules) can be located extraterritorially to the United States (e.g., in Canada and/or in one or more other foreign countries). However, the Presence Clients 205 can be located within the United States, such that the control of the System 200 as a whole is exercised and beneficial use of the System 200 is obtained by the user within the United States.

Each of modules of the System 200, including the Presence Clients 205, the Presence Information Priority Module 210, the Presence Information Communication Module 215, the Presence Information Sources 220, the Presence Information Priority Filter Module 225, and the Presence Information Priority Management Module 235, or any combination thereof, can be comprised of any suitable type of electrical or electronic component or device that is capable of performing the functions associated with the respective element. According to such an exemplary embodiment, each component or device can be in communication with another component or device using any appropriate type of electrical connection or communication link (e.g., wireless, wired, or a combination of both) that is capable of carrying such information. Alternatively, each of the modules of the System 200 can be comprised of any combination of hardware, firmware and software that is capable of performing the functions associated with the respective module.

Alternatively, the System 200 can be comprised of one or more microprocessors and associated memory(ies) that store the steps of a computer program to perform the functions of one or more of the modules of the System 200. The microprocessor can be any suitable type of processor, such as, for example, any type of general purpose microprocessor or microcontroller, a digital signal processing (DSP) processor, an application-specific integrated circuit (ASIC), a programmable read-only memory (PROM), an erasable programmable read-only memory (EPROM), an electrically-erasable programmable read-only memory (EEPROM), a computer-readable medium, or the like. The memory can be any suitable type of computer memory or any other type of electronic storage medium, such as, for example, read-only memory (ROM), random access memory (RAM), cache memory, compact disc read-only memory (CDROM), electro-optical memory, magneto-optical memory, or the like. As will be appreciated based on the foregoing description, the memory can be programmed using conventional techniques known to those having ordinary skill in the art of computer programming to perform the functions of one or more of the modules of the System 200. For example, the actual source code or object code of the computer program can be stored in the memory.

The System 200 can include suitable additional modules as necessary to assist or augment the functionality of any or all of the modules of the System 200. For example, the System 200 can include a database or storage module that can be in communication with, for example, one or more of modules of the Presence Server 230, the Presence Clients 205, the Presence Information Sources 220, and the Presence Information Priority Management Module 235. Such a storage module can be configured to store any suitable type of information generated or used by or with the System 200, including, for example, presence priority information, configuration information, presence information, and other like information. Such a storage module can be comprised of any suitable type of computer-readable or other computer storage medium capable of storing information in electrical or electronic form.

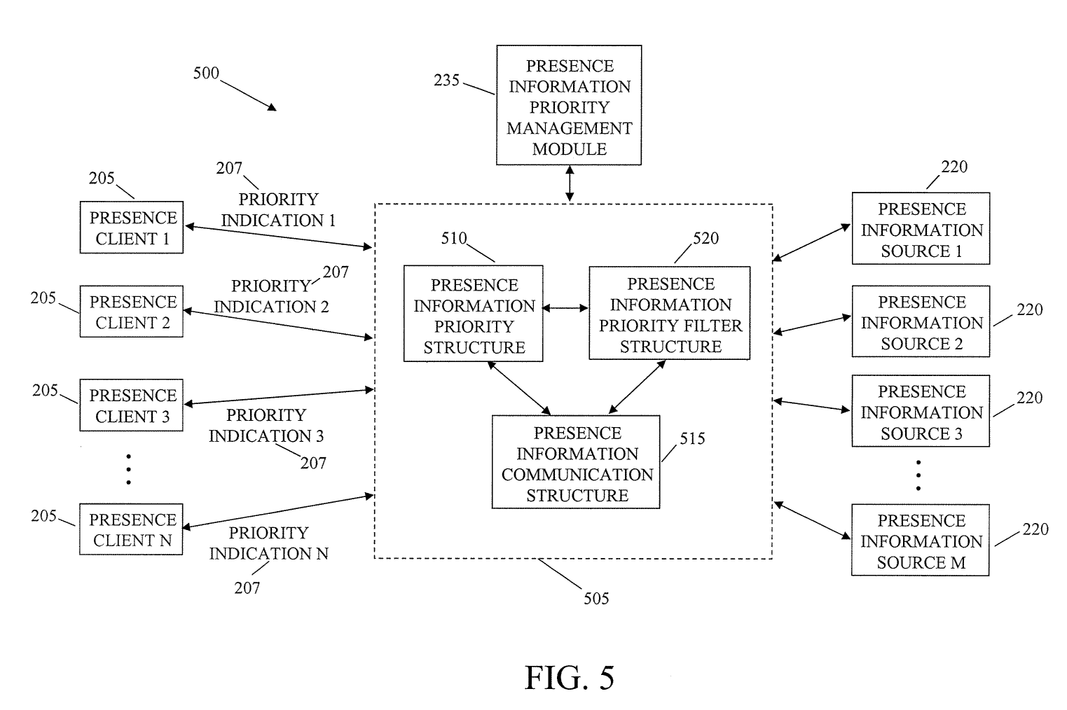

Alternative architectures or structures can be used to implement the various functions of the System 200 as described herein. For example, functions from two or more modules can be implemented in a single module, or functions from one module can be distributed among several different modules. For example, either or both of the Presence Information Communication Module 215 and the Presence Information Priority Filter Module 225 can form components of the Presence Information Priority Module 210, such that the Presence Information Priority Module 210 is configured to perform the functionality of those modules. Alternatively, the Presence Information Priority Module 210 can reside in each or any of the Presence Clients 205, such that the Presence Clients 205 are configured to generate and associate appropriate priority indications 207 for presence information received from the Presence Server 230. For purposes of illustration and not limitation, FIG. 5 is a block diagram illustrating a System 500 for prioritizing presence information for telecommunication, in accordance with an alternative exemplary embodiment of the present invention.

The System 500 includes a Presence Server 505. The Presence Server 505 includes Presence Information Priority Structure 510. The Presence Information Priority Structure 510 is configured to determine whether a Presence Client 205 supports presence information priority. The Presence Information Priority Structure 510 is also configured to associate a priority indication 207 with the presence information when it is determined that the Presence Client 205 supports presence information priority. The Presence Information Priority Structure 510 can perform such functionality in a manner similar to that described previously for the Presence Information Priority Module 210. The Presence Server 505 includes Presence Information Communication Structure 515 in communication with the Presence Information Priority Structure 510. The Presence Information Communication Structure 515 is configured to communicate the presence information and associated priority indication 207 to the Presence Client 205 (e.g., in a manner similar to that described previously for the Presence Information Communication Module 215). The Presence Server 505 can be configured to receive the presence information from one or more Presence Information Sources 220, for example, via the Presence Information Communication Structure 515. The Presence Server 505 can further include Presence Information Priority Filter Structure 520 in communication with the Presence Information Priority Structure 510. The Presence Information Priority Filter Structure 520 is configured to filter presence information for a Presence Client 205 in accordance with a predetermined priority indication 207 (e.g., in a manner similar to that described previously for the Presence Information Priority Filter Module 225). The System 500 can include a Presence Information Priority Management Module 235 in communication with the Presence Server 505, as discussed previously. Other alternative architectures or structures can be used to implement the various functions of the systems 200 and 500 as described herein.

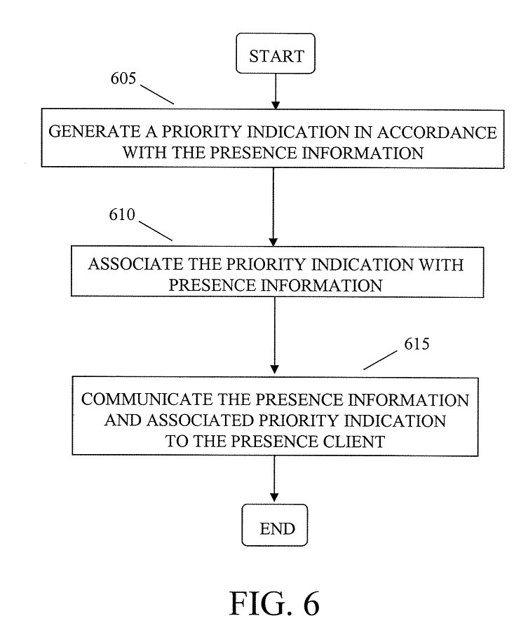

FIG. 6 is a flowchart illustrating steps for communicating presence information priority to presence clients, in accordance with an exemplary embodiment of the present invention. In step 605, a priority indication is generated in accordance with the presence information. In step 610, the priority indication is associated with presence information. For example, a substantially identical priority indication can be associated with the presence information for each presence client. However, a different priority indication can be associated with the presence information for each presence client. In step 615, the presence information and associated priority indication are communicated to the presence client.

According to an exemplary embodiment, the method can include the step of generating an alert notification by the presence client in response to receipt of the priority indication. For example, the alert notification can comprise at least one of a sound, a presence client awareness activity, and display of an alert message. Additionally or alternatively, communication between presence clients can be altered in response to receipt of the priority indication by the presence client.

According to an exemplary embodiment, the method can include the step of communicating the presence information to the presence client when the presence information is associated with a predetermined priority indication. Alternatively, the method can include the step of communicating the presence information to the presence client in accordance with a priority profile of the presence client. For example, the presence information for a presence client can be filtered in accordance with a predetermined priority indication.

According to an exemplary embodiment, the presence information can be received from a suitable presence information source. Consequently, the priority indication can be generated for the presence information by the presence information source in step 605. Additionally, a second priority indication can be generated for the presence information received from the presence information source. The priority indication generated by the presence information source can be overridden with the second priority indication under appropriate circumstances. Alternatively, the priority indication generated by the presence information source and the second priority indication can both be associated with the presence information. As an alternative, the method can comprise the step of augmenting or otherwise modifying the priority indication generated by the presence information source. According to an exemplary embodiment, the method can also comprise one or more of the following steps: receiving presence information priority preferences from the presence client for generating the priority indications; and managing presence information priority preferences for generating priority indications.

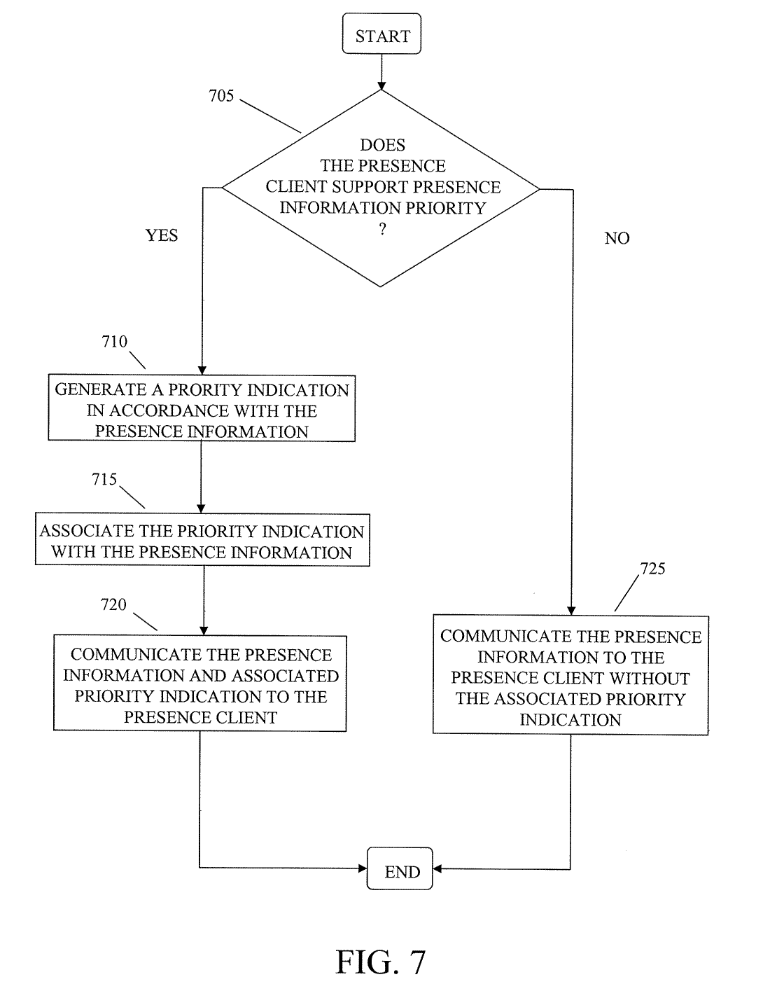

FIG. 7 is a flowchart illustrating steps for prioritizing presence information for telecommunication, in accordance with an alternative exemplary embodiment of the present invention. In step 705, a determination is made as to whether a presence client supports presence information priority. If it is determined in step 705 that the presence client does support presence information priority, then in step 710, a priority indication is generated in accordance with the presence information. According to exemplary embodiments, the priority indication is associated with one of a plurality of priority or severity levels of the presence information. Merely for purposes of illustration and not limitation, the priority indication can comprise, for example, a low priority level, a normal priority level, a high priority level, or other suitable priority or severity level or indication. In step 715, the priority indication is associated with the presence information when it is determined in step 705 that the presence client supports presence information priority. In addition, in step 720, the presence information and associated priority indication are communicated to the presence client. However, if it is determined in step 705 that the presence client does not support presence information priority, then in step 725, the presence information is communicated to the presence client without the associated priority indication.

The method can also include the step of generating an alert notification by the presence client in response to receipt of the priority indication. For example, the alert notification can comprise one or more of a sound, a presence client awareness activity, display of an alert message, or other suitable alert. The method can also include the step of filtering presence information for a presence client in accordance with a predetermined priority indication. For example, presence information priority preferences can be received from the presence client for generating the priority indications. The presence information can be communicated to the presence client when the presence information is associated with a predetermined priority indication as specified by the presence client's preferences. Additionally or alternatively, the presence information can be communicated to the presence client in accordance with a priority profile of the presence client. The presence client, a system administrator, or other suitable watcher or presentity can manage the presence information priority preferences for generating priority indications.

According to an exemplary embodiment, the presence information can be received from a remote presence information source. The remote or external presence information source can be configured to assign a first priority indication to the presence information. Accordingly, the method can include the steps of generating a second priority indication for the presence information received from the remote presence information source, and overriding the first priority indication with the second priority indication when the second priority indication is different than the first priority indication.

Each, all or any combination of the steps of a computer program as illustrated in, for example, FIGS. 6 and 7, or the presence information priority data structures discussed above can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. As used herein, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a non-exhaustive list) of the computer-readable medium can include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CDROM).

Exemplary embodiments of the present invention can be used in conjunction with any wireless or wired device, system or process for communicating information, including, but not limited to, telecommunication systems that use WiFi, WiMAX, or other suitable mobile wireless technologies. In particular, exemplary embodiments can be used in presence-based communication systems for supporting wireless communication, such as in mobile IM systems and the like.

It will be appreciated by those of ordinary skill in the art that the present invention can be embodied in various specific forms without departing from the spirit or essential characteristics thereof. The presently disclosed embodiments are considered in all respects to be illustrative and not restrictive. The scope of the invention is indicated by the appended claims, rather than the foregoing description, and all changes that come within the meaning and range of equivalence thereof are intended to be embraced.

All United States patents and patent applications, foreign patents and patent applications, and publications discussed above are hereby incorporated by reference herein in their entireties to the same extent as if each individual patent, patent application, or publication was specifically and individually indicated to be incorporated by reference in its entirety.

What is claimed is:

1. A system for communicating presence information priority to presence clients, comprising:
a presence information priority module,
wherein the presence information priority module is configured to associate a priority indication with presence information; and
a presence information communication module in communication with the presence information priority module,
wherein the presence information communication module is configured to communicate the presence information and associated priority indication to a presence client.

2. The system of claim 1, wherein the presence information priority module is configured to generate the priority indication in accordance with the presence information.

3. The system of claim 1, wherein the presence information priority module is configured to associate a different priority indication with the presence information for each presence client.

4. The system of claim 1, wherein the priority indication is associated with one of a plurality of priority levels of the presence information.

5. The system of claim 1, wherein the priority indication is configured to cause the presence client to generate an alert notification.

6. The system of claim 5, wherein the alert notification comprises at least one of a sound, a presence client awareness activity, and display of an alert message.

7. The system of claim 1, wherein the priority indication is configured to cause an alteration in communication between presence clients.

8. The system of claim 1, wherein the presence information communication module is configured to communicate the presence information to the presence client in accordance with a priority profile of the presence client.

9. The system of claim 1, comprising:
a presence information priority filter module in communication with the presence information priority module,
wherein the presence information priority filter module is configured to filter the presence information for a presence client in accordance with a predetermined priority indication.

10. The system of claim 1, wherein the presence information priority module is configured to receive the presence information from a presence information source.

11. The system of claim 10, wherein the presence information source is configured to assign the priority indication to the presence information.

12. The system of claim 11, wherein the presence information priority module is configured to generate a second priority indication for the presence information received from the presence information source.

13. The system of claim 12, wherein the presence information priority module is configured to override the priority indication assigned by the presence information source with the second priority indication.

14. The system of claim 12, wherein the presence information priority module is configured to associate the priority indication assigned by the presence information source and the second priority indication with the presence information.

15. The system of claim 11, wherein the presence information priority module is configured to modify the priority indication assigned by the presence information source.

16. The system of claim 1, wherein the presence information priority module is configured to receive presence information priority preferences from the presence client for generating the priority indications.

17. The system of claim 1, comprising:
a presence information priority management module in communication with the presence information priority module,
wherein the presence information priority management module is configured to manage presence information priority preferences for generating priority indications by the presence information priority module.

18. The system of claim 1, wherein the presence information priority module is configured to determine whether the presence client supports presence information priority,
wherein the presence information priority module is configured to associate the priority indication with the presence information when it is determined that the presence client supports presence information priority, and
wherein the presence information communication module is configured to communicate the presence information and associated priority indication to the presence client when the presence information priority module determines that the presence client supports presence information priority

19. The system of claim 18, wherein the presence information communication module is configured to communicate the presence information without the associated priority indication when the presence information priority module determines that the presence client does not support presence information priority.

20. A method of communicating presence information priority to presence clients, comprising the steps of:
a.) generating a priority indication in accordance with presence information;
b.) associating the priority indication with the presence information; and
c.) communicating the presence information and associated priority indication to the presence client.

21. The method of claim 20, wherein step (b) comprises the step of:
d.) associating a different priority indication with the presence information for each presence client.

22. The method of claim 20, wherein the priority indication is associated with one of a plurality of priority levels of the presence information.

23. The method of claim 20, comprising the step of:
d.) generating an alert notification by the presence client in response to receipt of the priority indication.

24. The method of claim 23, wherein the alert notification comprises at least one of a sound, a presence client awareness activity, and display of an alert message.

25. The method of claim 20, comprising the step of:
d.) altering communication between presence clients in response to receipt of the priority indication by the presence client.

26. The method of claim 20, comprising the step of:
d.) filtering the presence information for a presence client in accordance with a predetermined priority indication.

27. The method of claim 20, comprising the step of:
d.) receiving the presence information from a presence information source.

28. The method of claim 27, wherein step (a) comprises the step of:
e.) generating the priority indication for the presence information by the presence information source.

29. The method of claim 28, comprising the step of:
f.) generating a second priority indication for the presence information received from the presence information source.

30. The method of claim 29, comprising the step of:
g.) overriding the priority indication generated by the presence information source with the second priority indication.

31. The method of claim 29, wherein step (b) comprises the step of:
g.) associating the priority indication generated by the presence information source and the second priority indication with the presence information.

32. The method of claim 28, comprising the step of:
f.) augmenting the priority indication generated by the presence information source.

33. A computer-readable medium containing a presence information priority data structure for communicating priority indications with presence information, the presence information priority data structure comprising:
a plurality of presence information tuples,
wherein each presence information tuple comprises:
a status data structure for conveying status information,
wherein the status data structure comprises:
a priority indication for conveying presence information priority on the associated presence information; and
a communication address data structure,
wherein the communication address data structure comprises:
a communication mechanism data structure for indicating a type of messaging service used to communicate the presence information; and
a contact address data structure for indicating an address of an originator of the presence information.

34. The computer-readable medium of claim 33, wherein each presence information tuple comprises:
a markup information data structure.
